(19) United States
(12) Patent Application Publication
(10) Pub. No.: US 2009/0287802 A1
(43) Pub. Date: Nov. 19, 2009

(54) UPnP/DLNA device support apparatus, system, and method

(75) Inventors: Kirmo Koistinen, Oulu (FI); Kari Kaarela, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/153,396

(22) Filed: May 19, 2008

(51) Int. Cl. G06F 15/173; G06F 15/16

(52) U.S. Cl. 709/221; 709/224; 709/230

(57) ABSTRACT

An apparatus, system, and method may include a universal plug and play or digital living network alliance (UPnP/DLNA) device, a support server, and a mobile device. The mobile device may be configured to discover the UPnP/DLNA device of a UPnP or DLNA network by using a UPnP/DLNA protocol. The mobile device may further be configured to receive, using the UPnP/DLNA protocol, status-related data corresponding to the UPnP/DLNA device. The mobile device may also be configured to transmit the status-related data to the support server via a wide area network (WAN) or a wireless wide area network (WWAN) to facilitate support of the UPnP/DLNA device based on the status-related data.

### BACKGROUND OF THE INVENTION

1. Field of the Invention

The present invention relates generally to universal plug and play or digital living network alliance (UPnP/DLNA) networks. More specifically, the present invention relates to apparatuses, systems, and methods for providing support for UPnP/DLNA devices.

2. Description of the Related Art

Universal Plug and Play (UPnP) is one of the technical cornerstones of the Digital Living Network Alliance (DLNA). UPnP technology defines an architecture for pervasive peer-to-peer network connectivity of intelligent appliances, wireless devices, and personal computers. The UPnP Device Architecture (UDA) is designed to support zero-configuration, “invisible” networking, and automatic discovery for a breadth of device categories from a wide range of vendors. This means that a device can dynamically join a network, obtain an Internet Protocol (IP) address, convey its capabilities, and learn about the presence and capabilities of other devices. However, though UPnP is designed to be simple from a user standpoint, practical implementation often results in fairly complicated networking situations due to the large variety of devices, operations, and communications involved in a UPnP or DLNA network. These issues are, in large part, due to a lack of effective solutions for collecting and provisioning information about the UPnP or DLNA network in order to provide support for UPnP/DLNA devices.

### SUMMARY OF THE INVENTION

The present invention has been developed in response to the present state of the art, and in particular, in response to the problems and needs in the art that have not yet been fully solved by currently available communication system technologies. Accordingly, the present invention has been developed to provide a universal plug and play or digital living network alliance (UPnP/DLNA) device support apparatus, system, and method.

In one aspect of the present invention, a method may include discovering at least one UPnP/DLNA device of a UPnP or DLNA network by using a UPnP/DLNA protocol. The method may also include receiving, using the UPnP/DLNA protocol, status-related data corresponding to the at least one UPnP/DLNA device. The method may further include transmitting the status-related data to a support server via a wide area network (WAN) or a wireless wide area network (WWAN) to facilitate support of the at least one UPnP/DLNA device based on the status-related data.

In certain embodiments, the discovering and the collecting each comprise communicating with wireless and non-wireless devices via the UPnP or DLNA network. Also, the UPnP/DLNA protocol comprises a universal plug and play (UPnP) device control protocol (DCP). In certain embodiments, the method also includes receiving a support message regarding the at least one UPnP/DLNA device via the WAN/WWAN. In some embodiments, the support message originated from the support server or from a UPnP/DLNA device vendor. The method may also include communicating with the at least one UPnP/DLNA device regarding the support message received from the WAN/WWAN.

In some embodiments, the method includes receiving update instructions, via the WAN/WWAN, for updating the UPnP/DLNA device, executing the update instructions, storing the status-related data locally, and accessing the status-related data. In certain embodiments, the UPnP or DLNA network includes a network operating in accordance with universal plug and play (UPnP) technology and/or digital living network alliance (DLNA) technology.

In some embodiments, the discovering of the at least one UPnP/DLNA device includes receiving device description data. The device description data may include device identification information, device vendor information, device manufacturer information, a name and version of at least one hardware component, and a name and version of at least one software component. In certain embodiments, the receiving of the status-related data may include receiving performance error information, error logs, and media usage. In some embodiments, the discovering, the receiving, and the transmitting are each executed by a mobile device.

In another aspect of the present invention, an apparatus may include a discoverer configured to discover at least one UPnP/DLNA device of a UPnP or DLNA network by using a UPnP/DLNA protocol. The apparatus may also include a collector configured to receive, using the UPnP/DLNA protocol, status-related data corresponding to the at least one UPnP/DLNA device. The apparatus may also include a WAN/WWAN communicator configured to transmit the status-related data to a support server via a wide area network (WAN) or a wireless wide area network (WWAN) to facilitate support of the at least one UPnP/DLNA device based on the status-related data.

In certain embodiments, the discoverer and the communicator are each configured to communicate with wireless and non-wireless devices via the UPnP or DLNA network. The UPnP/DLNA protocol comprises a universal plug and play (UPnP) device control protocol (DCP). In some embodiments, the WAN/WWAN communicator is further configured to receive a support message regarding the at least one UPnP/DLNA device via the WAN/WWAN. In certain embodiments, the support message originates from the support server or from a UPnP/DLNA device vendor. The discoverer may further be configured to communicate with the at least one UPnP/DLNA device regarding the support message received from the WAN/WWAN. Additionally, the WAN/WWAN communicator may further be configured to receive update instructions, via the WAN/WWAN, for updating the UPnP/DLNA device and execute the update instructions.

In certain embodiments, the apparatus also includes a storer configured to store the status-related data locally and an accessor configured to access the status-related data. In some embodiments, the UPnP or DLNA network comprises a network operating in accordance with universal plug and play (UPnP) technology and/or digital living network alliance (DLNA) technology. Additionally, the discoverer, in order to discover the at least one UPnP/DLNA device, may be configured to receive device description data that includes device identification information, device vendor information, device manufacturer information, a name and version of at least one hardware component, and a name and version of at least one software component. Furthermore, the status-related data may include performance error information, error logs, and media usage.

In another aspect of the present invention, a computer program is embodied on a computer-readable medium. The computer program is configured to control a processor to perform operations that may include discovering at least one UPnP/DLNA device of a UPnP or DLNA network by using a UPnP/DLNA protocol and receiving, using the UPnP/DLNA protocol, status-related data corresponding to the at least one UPnP/DLNA device. The operations may also include transmitting the status-related data to a support server via a wide area network (WAN) or a wireless wide area network (WWAN) to facilitate support of the at least one UPnP/DLNA device based on the status-related data.

In another aspect of the present invention, an apparatus may include a discovery means for discovering at least one UPnP/DLNA device of a UPnP or DLNA network by using a UPnP/DLNA protocol. The apparatus may also include a receiving means for receiving, using the UPnP/DLNA protocol, status-related data corresponding to the at least one UPnP/DLNA device. The apparatus may further include a transmitting means for transmitting the status-related data to a support server via a wide area network (WAN) or a wireless wide area network (WWAN) to facilitate support of the at least one UPnP/DLNA device based on the status-related data.

In another aspect of the present invention, a method may include receiving, via a wide area network (WAN) or a wireless wide area network (WWAN), status-related data from a mobile device. The mobile device may be configured to receive status-related data from at least one UPnP/DLNA device of a UPnP or DLNA network by using a UPnP/DLNA protocol.

In certain embodiments, the UPnP/DLNA device of the UPnP or DLNA network may be a wireless or non-wireless device, and the UPnP/DLNA protocol may include a universal plug and play (UPnP) device control protocol (DCP). In certain embodiments, the method may also include enabling at least one device vendor server to access the status-related data and analyzing the status-related data to measure a performance of the UPnP or DLNA network. In some embodiments, the method may also include enabling a communication channel from the device vendor server to the at least one UPnP/DLNA device via the WAN/WWAN, the mobile device, and the UPnP or DLNA network.

In another aspect of the present invention, an apparatus include a mobile device communicator configured to receive, via a wide area network (WAN) or a wireless wide area network (WWAN), status-related data from a mobile device. The mobile device may be configured to receive status-related data from at least one UPnP/DLNA device of a UPnP or DLNA network by using a UPnP/DLNA protocol. [00161 In certain embodiments, the UPnP/DLNA device of the UPnP or DLNA network may be a wireless or non-wireless device, and the UPnP/DLNA protocol may include a universal plug and play (UPnP) device control protocol (DCP). In certain embodiments, the apparatus may include a vendor server communicator configured to enable at least one device vendor server to receive the status-related data and an analyzer configured to analyze the status-related data to measure a performance of the UPnP or DLNA network. In some embodiments, the apparatus may include a mobile device communicator configured to enable a communication channel from the device vendor server to the at least one UPnP/DLNA device via the WWAN, the mobile device, and the UPnP or DLNA network.

In another aspect of the present invention, a computer program is embodied on a computer-readable medium. The computer program may be configured to control a processor to perform operations that include receiving, via a wide area network (WAN) or a wireless wide area network (WWAN), status-related data from a mobile device. The mobile device is configured to receive status-related data from at least one UPnP/DLNA device of a UPnP or DLNA network by using a UPnP/DLNA protocol.

In another aspect of the present invention, an apparatus includes a receiving means for a receiving, via a wide area network (WAN) or a wireless wide area network (WWAN), status-related data from a mobile device. The mobile device is configured to receive status-related data from at least one UPnP/DLNA device of a UPnP or DLNA network by using a UPnP/DLNA protocol.

In another aspect of the present invention, a system may include at least one UPnP/DLNA device, a support server, and a mobile device. The mobile device may be configured to discover the at least one UPnP/DLNA device of a UPnP or DLNA network by using a UPnP/DLNA protocol. The UPnP or DLNA network may include wireless devices and non-wireless devices, and the UPnP/DLNA protocol may include a universal plug and play (UPnP) device control protocol (DCP). The mobile device may also be configured to receive, using the UPnP/DLNA protocol, status-related data corresponding to the at least one UPnP/DLNA device. The mobile device may further be configured to transmit the status-related data to the support server via a wide area network (WAN) or a wireless wide area network (WWAN) to facilitate support of the at least one UPnP/DLNA device based on the status-related data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of a UPnP/DLNA device support system, in accordance with one embodiment of the present invention;

FIG. 2 is a block diagram of a mobile device, in accordance with one embodiment of the present invention;

FIG. 3 is a block diagram of a support server, in accordance with one embodiment of the present invention;

FIG. 4 is a flow chart diagram of a UPnP/DLNA device support method, in accordance with an embodiment of the present invention;

FIG. 5 is a flow chart diagram of the UPnP/DLNA device support method, in accordance with an embodiment of the present invention;

FIG. 6 is a flow chart diagram of the UPnP/DLNA device support method, in accordance with an alternate embodiment of the present invention;

FIG. 7 is the UPnP/DLNA device support system, in accordance with an embodiment of the present invention; and

FIG. 8 is a sequence flow diagram, in accordance with one embodiment of the present invention.

### DETAILED DESCRIPTION OF THE PREFERRED EMBODIMENT(S)

It will be readily understood that the components of the present invention, as generally described and illustrated in the figures herein, may be arranged and designed in a wide variety of different configurations. Thus, the following more detailed description of the embodiments of the apparatus, system, and method of the present invention, as represented in the attached figures, is not intended to limit the scope of the invention, as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In addition, while the terms, data, packet, and/or datagram have been used in the description of the present invention, the invention has import to many types of network data. For purposes of this invention, the term data includes packet, cell, frame, datagram, bridge protocol data unit packet, packet data and any equivalents thereof.

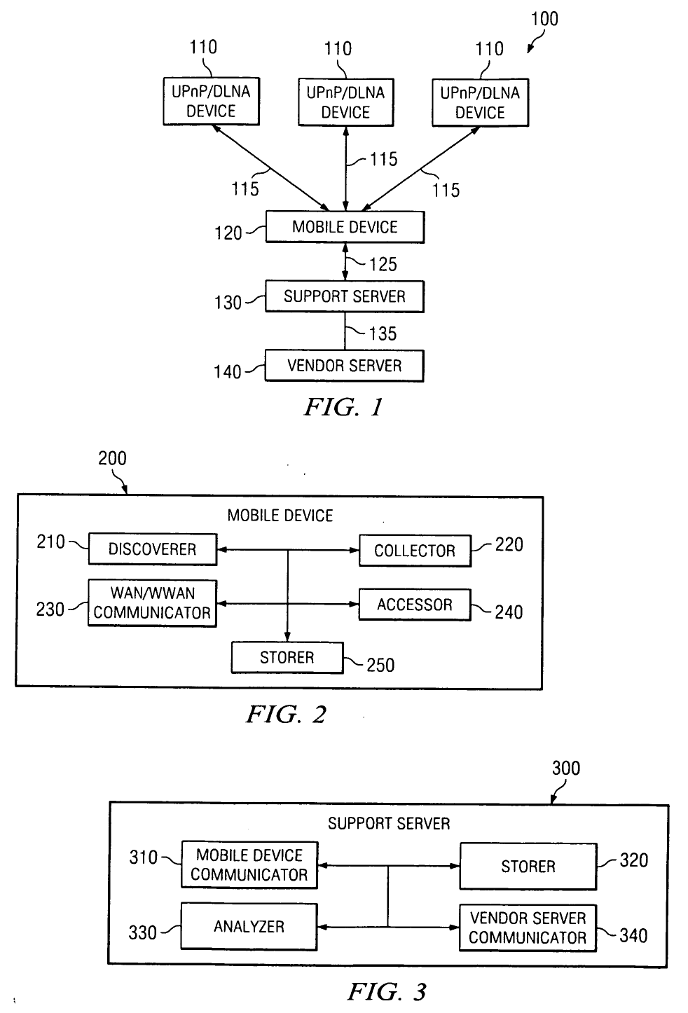

FIG. 1 is a block diagram of a UPnP/DLNA support system 100, in accordance with one embodiment of the present invention. The depicted system 100 includes universal plug and play or digital living network alliance (UPnP/DLNA) devices 110, a mobile device 120, a support server 130, and a vendor server 140. The components of the system 100 cooperate to facilitate convenient support for the UPnP/DLNA devices 110 by collecting status-related data from the UPnP/DLNA devices 110.

In some embodiments, the UPnP/DLNA devices 110 are part of a UPnP or DLNA network 115. The UPnP/DLNA devices 110 of the UPnP or DLNA network 115 may include wireless devices and/or non-wireless devices that are each configured to communicate with the mobile device 120. As such, the mobile device 120 may be configured to communicate with wireless and non-wireless UPnP/DLNA devices via a UPnP/DLNA protocol. The UPnP/DLNA protocol may include a universal plug and play (UPnP) device control protocol (DCP). The UPnP/DLNA devices 110 may include a large variety of devices such as personal computers, electronics, and appliances. Given the scope and nature of UPnP/DLNA technologies, one skilled in the art will appreciate the large variety of devices that may embody a UPnP/DLNA device of the present invention.

In certain embodiments, the mobile device 120 is configured to discover the UPnP/DLNA devices 110 by using UPnP/DLNA protocols. The mobile device 120 may also be configured to receive and store status-related data corresponding to the UPnP/DLNA devices 110. Additionally, the mobile device 120 may be configured to transmit the status-related data to the support server 130 via a wide area network (WAN) or a wireless wide area network (WWAN) 125 to facilitate support of the UPnP/DLNA devices 110 based on the status-related data. In certain embodiments, the status-related data may include metadata. As such, the mobile device 120 may be used as an intermediary for collecting and transmitting status-related data to a centralized repository, such as a support server 130.

In certain embodiments, the support server 130 may be configured to analyze the status-related data to determine a level of performance of the UPnP/DLNA devices 110 and/or the performance of the UPnP or DLNA network 115. For example, the support server 130 may analyze the status-related data to identify possible errors or bottlenecks in the standards used by the UPnP or DLNA network 115. In some embodiments, the support server 130 may communicate some or all of the status-related data to one or more vendor servers 140. In some embodiments, the support server 130 may do so via a wide area network (WAN), such as the Internet 135. The vendor server 140 may use the status-related data to determine a performance of the UPnP/DLNA devices 110 and to provide support to the UPnP/DLNA devices 110. In some embodiments, support may be provided to the UPnP/DLNA devices 110 via the mobile device 120 or via another route, such as the Internet. As such, the system 110 provides a convenient solution for supporting diverse UPnP/DLNA devices.

FIG. 2 is a block diagram of a mobile device 200, in accordance with one embodiment of the present invention. The depicted mobile device 200 includes a discoverer unit 210, a collector unit 220, a WAN/WWAN communicator unit 230, an accessor unit 240, and a storer unit 250. In certain embodiments, the mobile device 200 may correspond to the mobile device 120 of FIG. 1. In certain embodiments, the mobile device 200 may be a device implementing cellular technology, such as a cellular telephone, and universal plug and play or digital living network alliance (UPnP/DLNA) technology. The components of the mobile device 200 cooperate to facilitate support of UPnP/DLNA devices by collecting, storing, and transmitting status-related data of UPnP/DLNA devices to a centralized repository or server.

In certain embodiments, the discoverer 210 is configured to discover at least one UPnP/DLNA device of a UPnP or DLNA network by using a UPnP/DLNA protocol. The UPnP/DLNA device of the UPnP or DLNA network may include a wireless device or non-wireless device configured to communicate with the mobile device 200. As such, the mobile device 200 may be configured to communicate with wireless and non-wireless UPnP/DLNA devices via a UPnP/DLNA protocol. The UPnP/DLNA protocol may include a universal plug and play (UPnP) device control protocol (DCP). In some embodiments, the collector 220 is configured to collect status-related data corresponding to the UPnP/DLNA device in response to the discovery by the discoverer 210 of such a device. In some embodiments, the storer 250 is configured to locally store the status-related data and the accessor 240 is configured to provide access to the status-related data stored by the storer 250.

In certain embodiments, the WAN/WWAN communicator 230 is configured to interface with a support server (not shown) over a WAN/WWAN to transmit the status-related data to the support server to facilitate support of UPnP/DLNA devices. In some embodiments, the WAN/WWAN communicator 230 is configured to receive a support message regarding one or more UPnP/DLNA devices. The support message may include any information regarding the support of a UPnP/DLNA device and may originate from a support server or a device vendor (also not shown).

In certain embodiments, the WAN/WWAN communicator 230 may receive update instructions and data for updating one or more UPnP/DLNA devices. In some embodiments, instruction received may be executed or otherwise implemented by communicating with the UPnP/DLNA devices via the UPnP or DLNA network. As such, the mobile device 200 enables a solution for supporting UPnP/DLNA devices by collecting status-related data, by receiving update commands and instructions, and by executing the update commands and instructions. One skilled in the art will appreciate that these operations simplify supporting diverse UPnP/DLNA devices by consolidating the collection and analysis of status-related data.

FIG. 3 is a block diagram of a support server 300, in accordance with one embodiment of the present invention. The depicted support server 300 includes a mobile device communicator unit 310, a storer 320, an analyzer unit 330, and a vendor server communicator unit 340. In certain embodiments, the support server 300 corresponds to the support server 130 of FIG. 1. The components of the support server 300 facilitate the supporting of universal plug and play or digital living network alliance (UPnP/DLNA) devices or nodes.

In certain embodiments, the mobile device communicator 310 is configured to receive, via a WAN/WWAN (not shown), status-related data from a mobile device (not shown). In certain embodiments, the mobile device that transmits the status-related data to the support server 300 is configured to receive status-related data from UPnP/DLNA devices of a UPnP or DLNA network by using a UPnP/DLNA protocol.

In some embodiments, the analyzer 320 is configured to analyze the status-related data to measure a performance of the UPnP or DLNA network. In some embodiments, the analysis may include determining a performance level of the standards utilized by a UPnP or DLNA network. The analysis may also include determining the performance of an individual UPnP/DLNA device or a selected group of UPnP/DLNA devices. One skilled in the art will appreciate the variety of data analysis operations that could be executed by the support sever 300 in order to further facilitate support of the UPnP or DLNA network and UPnP/DLNA devices.

In certain embodiments, the vendor server communicator 340 may be configured to enable at least one device vendor server (not shown) to acquire the status-related data. Doing so enables the device vendor server to analyze the data and determine what support or upgrades would be desirable for a particular UPnP/DLNA device. For example, if the UPnP/DLNA device in question were a DVD player, the vendor server may utilize the status-related data to determine whether the DVD player is operating properly and/or whether a software upgrade or patch would be desirable. The device vendor server could then take steps to provide such support to the DVD player by opening a channel to UPnP/DLNA device via the support server 300 and mobile device, or via a more traditional route such as via the Internet. Accordingly, the support server 300 facilitates the support of UPnP/DLNA devices by receiving, storing, analyzing, and transmitting UPnP/DLNA device data.

It should be noted that many of the functional units described in this specification have been presented as units, such as the discoverer unit 210, the collector 220, the WAN/WWAN communicator unit 230, the accessor unit 240, the storer unit 250, the mobile device communicator unit 310, the storer unit 320, the analyzer unit 330, and the vendor server communicator unit 340 of FIG. 2 and FIG. 3., in order to more particularly emphasize their implementation independence. For example, a unit may be implemented as a hardware circuit comprising custom VLSI circuits or gate arrays, off-the-shelf semiconductors such as logic chips, transistors, or other discrete components. A unit may also be implemented in programmable hardware devices such as field programmable gate arrays, programmable array logic, programmable logic devices or the like.

Units may also be partially implemented in software for execution by various types of processors. An identified unit of executable code may, for instance, comprise one or more physical or logical blocks of computer instructions which may, for instance, be organized as an object, procedure, or function. Nevertheless, the executables of an identified unit need not be physically located together, but may comprise disparate instructions stored in different locations which, when joined logically together, comprise the unit and achieve the stated purpose for the unit.

Indeed, a unit of executable code could be a single instruction, or many instructions, and may even be distributed over several different code segments, among different programs, and across several memory devices. Similarly, operational data may be identified and illustrated herein within units, and may be embodied in any suitable form and organized within any suitable type of data structure. The operational data may be collected as a single data set, or may be distributed over different locations including over different storage devices, and may exist, at least partially, merely as electronic signals on a system or network.

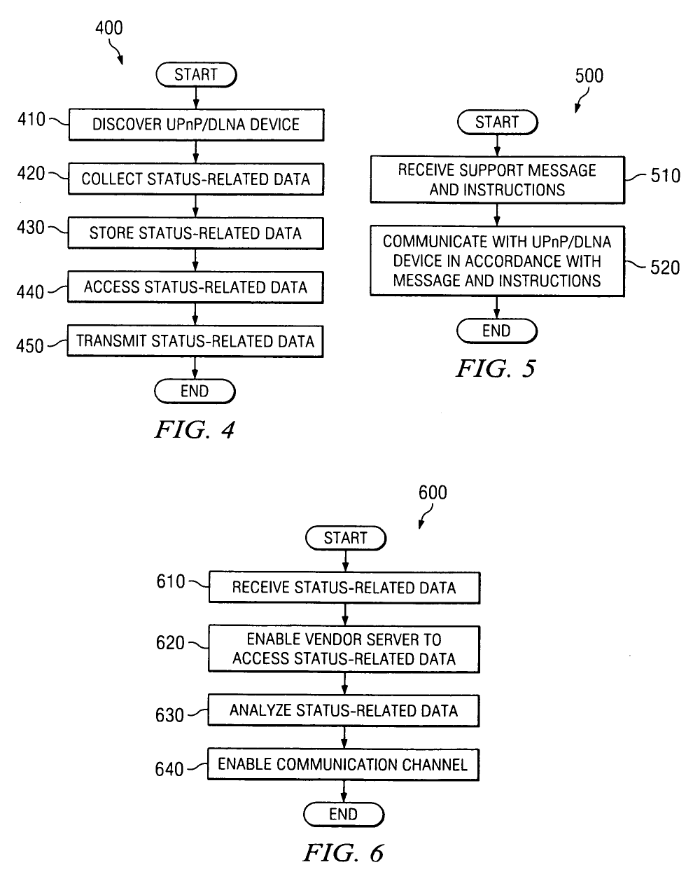

FIG. 4 is a flow chart diagram of a universal plug and play or digital living network alliance (UPnP/DLNA) device support method 400, in accordance with one embodiment of the present invention. The depicted method 400 includes discovering 410 a UPnP/DLNA device, collecting 420 status-related data, storing 430 the status-related data, accessing 440 the status-related data, and transmitting 450 the status-related data. In certain embodiments, the operations of the method 400 may correspond to the mobile devices 120 of FIG. 1 and/or the mobile device 200 of FIG. 2. The operations of the method 400 facilitate support of UPnP/DLNA devices.

Discovering 410 a UPnP/DLNA device may include a mobile device, such as a cellular telephone, executing operations in accordance with one or more UPnP/DLNA protocols to determine the existence of one or more UPnP/DLNA devices in a UPnP or DLNA network. The UPnP/DLNA device of the UPnP or DLNA network may include wireless devices and non-wireless devices that are each configured to communicate with a mobile device. As such, the mobile device may be configured to communicate with wireless and non-wireless UPnP/DLNA devices via a UPnP/DLNA protocol. The UPnP/DLNA protocol may include a universal plug and play (UPnP) device control protocol (DCP). Discovering 410 may also include receiving device description data that includes device identification information, device vendor information, device manufacturer information, a name and version of at least one hardware component, and a name and version of at least one software component.

Collecting 420 status-related data may include a mobile device communicating with one or more UPnP/DLNA devices to obtain information that includes performance error information, error logs, and media usage. One skilled in the art will appreciate that the information obtained in the discovering 410 and the collecting 420 operations may include a variety of information and is not limited to the types of information specifically mentioned herein. However, the data collected should be relevant to supporting UPnP/DLNA devices.

Storing 430 status-related data may include a mobile device locally storing status information received from UPnP/DLNA network. The amount and type of storage media may vary depending upon the embodiment. Accessing 440 may include a mobile phone accessing status-related data stored therein in order to transmit the status-related data to a support server.

Transmitting 450 the status-related data may include a mobile device transmitting status-related data to a support server to facilitate supporting a UPnP/DLNA device. One skilled in the art will appreciate that the transmitting 450 may be executed according to a pre-selected schedule, upon the occurrence of a pre-selected event such as receiving a transmittal request, upon expiration of a pre-determined interval, or upon reaching a storage threshold. Accordingly, executing the depicted method 400 facilitates support of UPnP/DLNA devices

FIG. 5 is a flow chart diagram of a universal plug and play or digital living network alliance (UPnP/DLNA) device support method 500, in accordance with an embodiment of the present invention. The depicted method 500 includes receiving 510 a support message and instructions and communicating 520 with a UPnP/DLNA device in accordance with the message and instructions. In certain embodiments, the operations of method 500 may be attributed to the mobile devices 120 of FIG. 1 and/or the mobile device 200 of FIG. 2. The operations of the method 500 facilitate UPnP/DLNA device support by receiving messages and instructions and by updating the UPnP/DLNA device in accordance with the messages and instructions received.

Receiving 510 a support message and instructions may include a mobile device receiving data from a support server regarding support for a UPnP/DLNA device. One skilled in the art will appreciate that the support message and instruction may be embodied in a large variety of forms. For example, the support message and instructions may include a notification of how the mobile device should interact with the UPnP/DLNA device in the future. The support message and instructions may also include data and instructions for updating software and/or hardware of the UPnP/DLNA device.

Communicating 520 with the UPnP/DLNA device may include a mobile device communicating update information to a UPnP/DLNA device via a UPnP or DLNA network in accordance with a UPnP/DLNA protocol. The UPnP/DLNA device of the UPnP or DLNA network may include a wireless device or non-wireless device configured to communicate with the mobile device. As such, the mobile device may be configured to communicate with wireless and non-wireless UPnP/DLNA devices via a UPnP/DLNA protocol. The UPnP/DLNA protocol may include a universal plug and play (UPnP) device control protocol (DCP). The update information may include notifications of a need to update hardware or software and may also include actual data and software instructions for updating the UPnP/DLNA device. Accordingly, the method 500 provides a solution for providing support for UPnP/DLNA devices.

FIG. 6 is a flow chart diagram of a universal plug and play or digital living network alliance (UPnP/DLNA) device support method 600, in accordance with an alternative embodiment of the present invention. The depicted method 600 includes the operations of receiving 610 status-related data, enabling 620 access to the status-related data, analyzing 630 the status-related data, and enabling 640 a communication channel. In some embodiments, the method 600 may be executed by a support server 130 as depicted in FIG. 1 and/or a support server 300 as depicted in FIG. 3. The operations of the method 600 facilitate UPnP/DLNA device support.

Receiving 610 status-related data may include a support server receiving status-related data from a mobile device. As described elsewhere, the status-related information may include information of the operational status of a UPnP/DLNA device. Enabling 620 access to the status-related data may include a support server transmitting, communicating, or otherwise granting access of the status-related data to a vendor server.

Analyzing 630 the status-related data may include a support server analyzing the data to determine certain performance issues such as the performance status of a standard being used by a UPnP or DLNA network to which a UPnP/DLNA device corresponds. Enabling 650 a communication channel may include a support server enabling communication between the vendor server and the UPnP/DLNA device to facilitate UPnP/DLNA device updates. Accordingly, the depicted method 600 provides a solution for facilitating support of UPnP/DLNA devices.

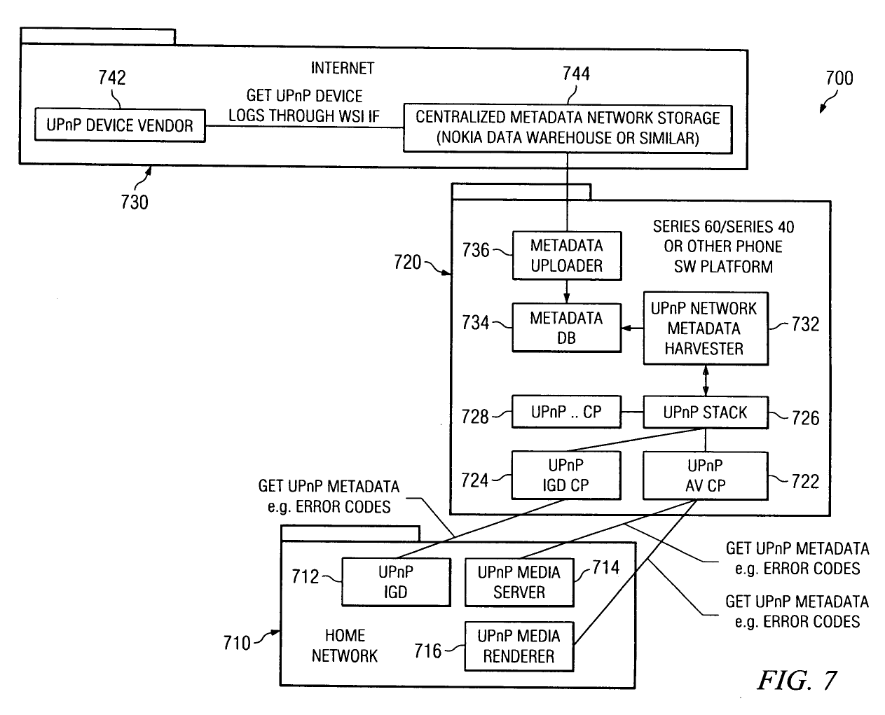

FIG. 7 is the UPnP/DLNA support system 700, in accordance with an embodiment of the present invention. The depicted system 700 includes a home network 710, a phone software platform 720, and the Internet 730. The system 700 represents one of many embodiments for a universal plug and play or digital living network alliance (UPnP/DLNA) device support system in accordance with the present invention.

As depicted, the home network 710 includes various UPnP/DLNA devices such as a universal plug and play (UPnP) internet gateway device (IGD) 712, a UPnP media server 714, and a UPnP media renderer 716. Each of the network devices 712, 714, 716 are configured to operate in accordance with UPnP technology and are examples of UPnP/DLNA devices described herein.

Also, the phone software platform 720 may correspond to a series 60, a series 40, or another phone software platform. The depicted phone software platform 720 includes a UPnP IGD control point (CP) 724, a UPnP audio video (AV), a control point (CP) 722, other UPnP control points (CPs) 728, a UPnP stack 726, a UPnP network metadata harvester 732, a metadata database (DB) 734, and a metadata uploader 736. In certain embodiments, the depicted phone software platform 720 may correspond to the mobile device 200 of FIG. 2. As indicated by FIG. 7, a mobile phone may be used to implement control points for several UPnP device control protocols if needed to accomplish the objectives of the present invention. The components of the phone software platform 720 provide examples of the components described in FIG. 2 above and operate to facilitate the providing of support to UPnP/DLNA devices by discovering, collecting, and transmitting status-related data of UPnP/DLNA devices.

Additionally, the Internet 730 includes a centralized metadata network storage 744 in communication with the phone software platform 720 and the UPnP device vendor 742. In some embodiments, centralized metadata network storage 744 is one example of a support server 130 described above. Also, the UPnP device vendor 742 may be an example of a device vendor server described above 140. As such, the system 700 of FIG. 7 provides an embodiment of a UPnP/DLNA device support system in accordance with the present invention.

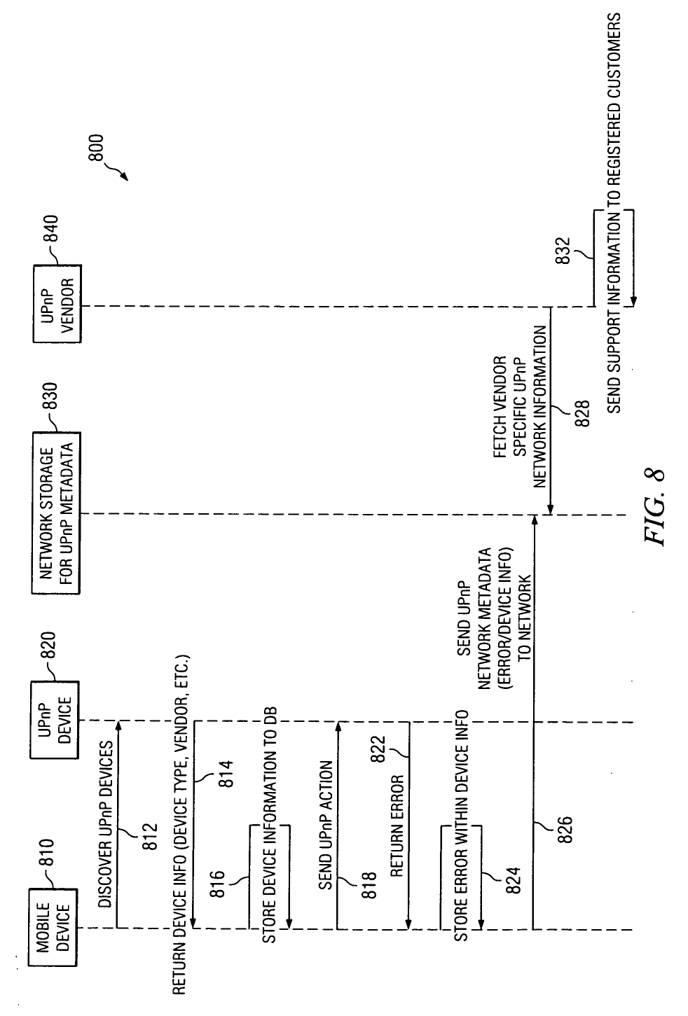

FIG. 8 is one embodiment of a sequence flow diagram 800, in accordance with the present invention. The depicted sequence flow diagram 800 includes a mobile device 810, a universal plug and play or digital living network alliance (UPnP/DLNA) device 820, a network storage for UPnP metadata 830, and a UPnP vendor 840. The components and operations depicted in the sequence flow diagram 800 represents one embodiment of the present invention.

The sequence flow diagram 800 begins by the mobile 810 device discovering 812 the UPnP device 820. Then, the UPnP device 820 returns 814 device information such as a device type and a vendor information. Upon receiving the device information, the mobile device 810 stores 816 the device information to a local database and sends 8181 a UPnP action to the UPnP device 820. In response to the UPnP action, the UPnP device returns 822 an error which is stored 824 by the mobile device 810.

Upon collecting and storing the device data and the error, the mobile device 810 sends the UPnP network metadata (i.e., the error and device information) to the network storage for UPnP metadata 830. Then, the UPnP vendor 840 fetches 828 the UPnP metadata from the network storage 830. Upon fetching 828 the data, the UPnP vendor sends 832 support information to the registered customer.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

We claim:

1. A method comprising:
discovering a universal plug and play or digital living network alliance (UPnP/DLNA) device of a UPnP or DLNA network using a UPnP/DLNA protocol;
collecting, using the UPnP/DLNA protocol, status-related data corresponding to the at least one UPnP/DLNA device; and
transmitting the status-related data to a support server via a wide area network (WAN) or a wireless wide area network (WWAN) to facilitate support of the UPnP/DLNA device based on the status-related data.

2. The method of claim 1, further comprising:
receiving a support message regarding the at least one UPnP/DLNA device via the WAN/WWAN.

3. The method of claim 2, wherein the support message is received from the support server or from a UPnP/DLNA device vendor.

4. The method of claim 2, further comprising:
communicating with the UPnP/DLNA device regarding the support message received from the WAN/WWAN.

5. The method of claim 1, further comprising:
receiving update instructions, via the WAN/WWAN, for updating the UPnP/DLNA device; and
executing the update instructions.

6. The method of claim 1, further comprising:
storing the status-related data locally; and
accessing the status-related data.

7. The method of claim 1, wherein the UPnP or DLNA network comprises a network operating in accordance with universal plug and play (UPnP) technology and/or digital living network alliance (DLNA) technology.

8. The method of claim 1, wherein the discovering of the UPnP/DLNA device comprises receiving device description data comprising device identification information, device vendor information, device manufacturer information, a name and version of at least one hardware component, and a name and version of at least one software component.

9. The method of claim 1, wherein the receiving of the status-related data comprises receiving performance error information, error logs, and media usage.

10. The method of claim 1, wherein the discovering, the collecting, and the transmitting are each executed by a mobile device.

11. The method of claim 1, wherein the discovering and the collecting each comprise communicating with wireless and non-wireless devices via the UPnP or DLNA network.

12. The method of claim 1, wherein the UPnP/DLNA protocol comprises a universal plug and play (UPnP) device control protocol (DCP).

13. An apparatus, comprising:
a discoverer configured to discover universal plug and play or digital living network alliance (UPnP/DLNA) device of a UPnP or DLNA network using a UPnP/DLNA protocol;
a collector configured to collect, using the UPnP/DLNA protocol, status-related data corresponding to the at least one UPnP/DLNA device; and
a communicator configured to transmit the status-related data to a support server via a wide area network (WAN) or a wireless wide area network (WWAN) to facilitate support of the UPnP/DLNA device based on the status-related data.

14. The apparatus of claim 13, wherein the communicator is further configured to receive a support message regarding the UPnP/DLNA device via the WAN/WWAN.

15. The apparatus of claim 14, wherein the support server or a UPnP/DLNA device vendor transmitted to the communicator the support message.

16. The apparatus of claim 14, wherein the discoverer is further configured to communicate with the at least one UPnP/DLNA device regarding the support message received from the WAN/WWAN.

17. The apparatus of claim 13, wherein the communicator is further configured to receive update instructions, via the WAN/WWAN, to update the UPnP/DLNA device and execute the update instructions.

18. The apparatus of claim 13, further comprising:
a storer configured to store the status-related data locally; and
an accessor configured to access the status-related data.

19. The apparatus of claim 13, wherein the UPnP or DLNA network comprises a network operating in accordance with universal plug and play (UPnP) technology and/or digital living network alliance (DLNA) technology.

20. The apparatus of claim 13, wherein the discoverer is configured to receive device description data comprising device identification information, device vendor information, device manufacturer information, a name and version of at least one hardware component, and a name and version of software component to discover the UPnP/DLNA device.

21. The apparatus of claim 13, wherein the status-related data comprises performance error information, error logs, and media usage.

22. The apparatus of claim 13, wherein the discoverer and the communicator are each configured to communicate with wireless and non-wireless devices via the UPnP or DLNA network.

23. The apparatus of claim 13, wherein the UPnP/DLNA protocol comprises a universal plug and play (UPnP) device control protocol (DCP).

24. A computer program embodied on a computer-readable medium, the computer program configured to control a processor to perform operations comprising:
discovering a universal plug and play or digital living network alliance (UPnP/DLNA) device of a UPnP or DLNA network using a UPnP/DLNA protocol;
collecting, using the UPnP/DLNA protocol, status-related data corresponding to the UPnP/DLNA device; and
transmitting the status-related data to a support server via a wide area network (WAN) or a wireless wide area network (WWAN) to facilitate support of the UPnP/DLNA device based on the status-related data.

25. An apparatus, comprising:
discovery means for discovering a universal plug and play or digital living network alliance (UPnP/DLNA) device of a UPnP or DLNA network using a UPnP/DLNA protocol;
collecting means for collecting, using the UPnP/DLNA protocol, status-related data corresponding to the UPnP/DLNA device; and
transmitting means for transmitting the status-related data to a support server via a wide area network (WAN) or a wireless wide area network (WWAN) to facilitate support of the UPnP/DLNA device based on the status-related data.

26. A method, comprising:
receiving, via a wide area network (WAN) or a wireless wide area network (WWAN), status-related data from a mobile device, wherein the mobile device is configured to receive status-related data from a universal plug and play or digital living network alliance (UPnP/DLNA) device of a UPnP or DLNA network using a UPnP/DLNA protocol.

27. The method of claim 26, further comprising:
enabling a device vendor server to access the status-related data.

28. The method of claim 26, further comprising:
analyzing the status-related data to measure a performance of the UPnP or DLNA network.

29. The method of claim 26, further comprising:
enabling a communication channel from the device vendor server to the UPnP/DLNA device via the WAN/WWAN, the mobile device, and the UPnP or DLNA network.

30. The method of claim 26, wherein the UPnP or DLNA network comprises wireless and non-wireless device configured to communicate with the mobile device via the UPnP/DLNA protocol.

31. The method of claim 26, wherein the UPnP/DLNA protocol comprises a universal plug and play (UPnP) device control protocol (DCP).

32. An apparatus, comprising:
a mobile device communicator configured to receive, via a wide area network (WAN) or a wireless wide area network (WWAN), status-related data from a mobile device, wherein the mobile device is configured to receive status-related data from a universal plug and play or digital living network alliance (UPnP/DLNA) device of a UPnP or DLNA network using a UPnP/DLNA protocol.

33. The apparatus of claim 32, further comprising:
a vendor server communicator configured to enable a device vendor server to receive the status-related data.

34. The apparatus of claim 32, further comprising:
an analyzer configured to analyze the status-related data to measure a performance of the UPnP or DLNA network.

35. The apparatus of claim 32, further comprising:
a mobile device communicator configured to enable a communication channel from the device vendor server to the UPnP/DLNA device via the WAN/WWAN, the mobile device, and the UPnP or DLNA network.

36. The apparatus of claim 32, wherein the UPnP or DLNA network comprises wireless and non-wireless device configured to communicate with the mobile device via the UPnP/DLNA protocol.

37. The apparatus of claim 32, wherein the UPnP/DLNA protocol comprises a universal plug and play (UPnP) device control protocol (DCP).

38. A computer program embodied on a computer-readable medium, the computer program configured to control a processor to perform operations comprising:
receiving, via a wide area network (WAN) or a wireless wide area network (WWAN), status-related data from a mobile device, wherein the mobile device is configured to receive status-related data from a universal plug and play or digital living network alliance (UPnP/DLNA) device of a UPnP or DLNA network using a UPnP/DLNA protocol.

39. An apparatus, comprising:
receiving means for a receiving, via a wide area network (WAN) or a wireless wide area network (WWAN), status-related data from a mobile device, wherein the mobile device is configured to receive status-related data from a universal plug and play or digital living network alliance (UPnP/DLNA) device of a UPnP or DLNA network using a UPnP/DLNA protocol.

40. A system, comprising:
a universal plug and play or digital living network alliance (UPnP/DLNA) device;
a support server; and
a mobile device,
the mobile device configured to
discover the UPnP/DLNA device of a UPnP or DLNA network by using a UPnP/DLNA protocol,
collect, using the UPnP/DLNA protocol, status-related data corresponding to the UPnP/DLNA device, and
transmit the status-related data to the support server via a wide area network (WAN) or a wireless wide area network (WWAN) to facilitate support of the UPnP/DLNA device based on the status-related data.
